(19) United States
(12) Patent Application Publication
(10) Pub. No.: US 2010/0090471 A1
(43) Pub. Date: Apr. 15, 2010

(54) ELASTODYNAMIC ENERGY ACCUMULATOR-REGULATOR

(75) Inventors: Julian Casero Fernandez-Montes, Madrid (ES); Emilio Bautista Paz, Madrid (ES); Jose Luis Munoz Sanz, Madrid (ES); Juan Manuel Munoz Guijosa, Madrid (ES)

Correspondence Address: CANTOR COLBURN, LLP, 20 Church Street, 22nd Floor, Hartford, CT, 06103, US

(73) Assignee: ACUMENER INVESTIGACION Y DESARROLLO, S.L., Madrid (ES)

(21) Appl. No.: 12/516,501

(22) PCT Filed: Nov. 27, 2006
(86) PCT No.: PCT/EP06/68962

§ 371 Date: Dec. 22, 2009

(51) Int. Cl. F03D 9/00; F16F 1/06; B60K 8/00

(52) U.S. Cl. 290/55; 267/155; 180/54.2

(57) ABSTRACT

The elastodynamic energy accumulator-regulator comprises a sheet (1) that is wound or capable of being wound in radioida spiral form with increasing or decreasing curvature along the length of the spiral, capable of absorbing energy at variable torque and supply a practically constant torque in broad working areas The laminate or set of sheets that are wound or capable of being wound about themselves as a spring has variable thickness and/or width and/or reinforcement along its length, and is held at both ends. The laminate or set of sheets is made of composite materials with polymer matrix and fiber reinforcement This elastodynamic energy accumulator-regulator has application as an energy accumulator or regulator in many applications such as wind energy production and other renewable energies, applications in transport, applications in uninterruptible power supply systems, applications in electric network regulation, etc.

### OBJECT OF THE INVENTION

The object of the present invention refers to an elastodynamic energy accumulator-regulator, to a manufacturing procedure for said elastodynamic energy accumulator and to different preferred applications for the use of said elastodynamic energy accumulator.

The invention is set within the technical field of energy-accumulating mechanical devices. This energy can be accumulated when there is an excess in the producing device and the device is able to supply that energy in non-production states of energy, or when the application or the user need it.

### BACKGROUND OF THE INVENTION

The problems that have always existed with energy are well known, since energy has the problem of its accumulation in sufficient amounts as to be later used cost-effectively and when people so desire.

Amongst the energy-producing means currently in existence, nuclear power stations and thermal power stations can be mentioned, which are responsible for the main energetic production of different countries. Due to their design configuration and in order to obtain a greater energetic yield, this kind of power station must be in constant operation, that is, without stop and start-up procedures and with a constant energy production regime. This does not adapt to the energy demands of a country in which there are times of maximum or minimum consumption in accordance with human activity. There are thus trough hours of minimum energy consumption such as night-time, when human activity is considerably reduced, and hours of maximum consumption during the day when industrial activity coincides with heat or cold waves, for example, in which consumption rises considerably.

There are hydraulic power stations in which energy is produced by the fall of water stored in reservoirs. There is the advantage that this energy is accumulated in the form of water held in a reservoir, and therefore when flow conditions so allow, it is an effective means of energy regulation. Furthermore, in the event of an excess of energetic production by other means, it allows pumping water towards the header reservoirs, thus achieving energy accumulation in the form of water taken to the header reservoirs. This procedure does not offer great efficiency, but it is at least a manner of making use of excess energy at times of little demand and great energy production from other power stations. This procedure also clashes with times in which the scarcity of the water flow in rivers does not allow carrying out such operations.

There is another kind of energy such as wind energy in which the energy from the wind is transformed into electric energy through wind-powered generators. Amongst these generators we can name horizontal wind-powered generators, which are the most widespread. These consist of a mast on the end of which is arranged the horizontal shaft, one end of which is attached to the vanes that gather the wind power in order to transform it into rotational mechanical energy. On the opposite end of the shaft is the electric generator, both located on the upper end of the mast that makes up the wind-powered generator.

Amongst the vertical wind-powered generators we can mention the Darrieus and Giromill flat-vane generator, which despite having experienced less development have always had good yield results, similar or in some cases above those of horizontal wind-powered generators, especially at low wind speeds.

The problem of wind energy is that energy is not produced when there is no wind or when the wind is very strong, in the latter case this is to prevent damaging the components, which generates numerous imbalances on the electric network of different countries due to its use, which is preventing mass use of this kind of energy.

As can be understood, there is currently a great imbalance between energy production means and the consumption means thereof, which makes us understand that it would be desirable to have energy accumulation means available that would serve to regulate this production, adapting it to energy consumption, which would allow a more rational management of energy production of a region, a country or a continent, since the electric networks of different countries are interconnected and local solutions would be unreasonable.

Amongst the energy accumulation means we can mention, for example, electrochemical accumulators or batteries that allow accumulating electric energy in a limited manner, the problem being the great amount of space they take up and the weight of such batteries. Furthermore, their yields are not at all impressive and some of their components are great pollutants.

There are mechanical accumulators such as springs in which energy accumulation is relatively small and the torque both for its charging and discharging is not constant, which makes them unviable for industrial use.

The use of very large Belleville washers has been studied. Their energy accumulation is quite limited, since they are based on the elastic effect of these conical configuration washers, arranged in groups so that the elastic effect thereof reaches ideal values for their use.

Finally, we mention storing energy by means of momentum wheels that also have the drawback of the scarce energy they accumulate given the space that such devices occupy. Said devices consist in a large wheel of considerable mass in which energy is accumulated as kinetic energy by the movement of said wheels. These wheels supply their energy through the momentum accumulated by the moving mass within the accumulator itself.

### DESCRIPTION OF THE INVENTION

It is therefore an object of the invention to achieve a mechanical means that is able to accumulate a great amount of energy in a reasonable minimum space.

It is likewise an object of the invention to allow this energy accumulation element to absorb mechanical energy at variable torque and to supply it at constant torque for an ideal use thereof.

When mentioning that energy supply will be performed at constant torque, this means that the torque remains at practically constant values in the greatest possible working area of the mechanical organ.

This accumulator proposed by the invention becomes an energetic regulator, since it can accumulate energy at times of excess thereof and supply it at times of shortage.

The object of the present invention refers to an elastodynamic energy accumulator-regulator comprising a sheet that is wound or capable of being wound in radioidal spiral form with increasing or decreasing curvature along the length of the spiral and that is capable of absorbing energy at variable torque and supply a practically constant torque throughout broad working areas. Said invention achieves complete independence of energy input and output thereof, elastodynamically regulating the output torque.

This sheet wound in radioidal spiral form achieves absorbing energy at variable torque and supplying an almost constant torque in broad working areas, which makes this mechanical system completely usable as an energy accumulator. No mechanical energy accumulating systems are currently known that supply energy at a constant torque.

The sheet wound or capable of being wound in radioidal spiral form has a linearly increasing or decreasing curvature along the length of the spiral, which is an essential feature in order to achieve this supply torque at a practically constant torque in broad working areas.

The laminate or set of wound sheets or sheets capable of being wound upon themselves in the manner of a spring has a variable width and/or thickness and/or reinforcement along its length, held on both ends, that is, with any of the variables or by combining them all, an elastodynamic accumulator-regulator that is capable of absorbing energy at a variable torque and supplying it at a constant torque can be achieved, and it is therefore possible to achieve multiple embodiments of the wound sheet in order to obtain the same function.

The laminate or set of sheets is made of materials based on a polymer matrix and a fiber reinforcement that achieves high elastic deformability with respect to other materials, although the use of currently known materials such as steel or future materials with which a very high degree of elasticity may be achieved, must not be ruled out.

Materials that can be considered as most ideal for this application are to be found in composite materials formed by a mixture of resins and fibers, placed in successive layers and with interwoven fibers in order to achieve greater elasticity of the materials. These composite materials must be cured, which is achieved by applying heat during the curing process. Amongst the materials used and by way of examples we can mention boron/epoxy, graphite/epoxy, fiberglass/epoxy and aramid/epoxy, without ruling out the use of any other materials that meet the condition of being highly resistant composite materials.

These wound sheets can be mechanically connected and for example at least two sheets wound or sheets that can be wound in radioidal spiral form can be mechanically connected in series. With this connection in series the mechanical torque for charging and discharging the sheets is the sum of the torques for both sheets. These wound sheets can likewise be mechanically connected in parallel. In this case both the torque they absorb and the torque they supply is the same as that of a single sheet body but the energy accumulated is equal to the sum of the energy accumulated in each one of the accumulators.

The latter option may be the most advisable, since the energy accumulated is equal to the sum of the energy accumulated individually in each one of the sheets.

Likewise, in the ideal configuration intended to be performed, several configurations can be set up depending on the application, made up of more than two wound sheets or sheets capable of being wound in a radioidal spiral form connected in series and in parallel. That is, all possible combinations in series or in parallel can be performed since they are very adequate means of accumulating elastodynamic energy (parallel) and peak absorption (series).

The manufacturing process for a wound sheet or a sheet that is capable of being wound in radioidal spiral form such as that shown in the invention is also an object of the invention.

Manufacture of this sheet in an adequate shape starts from a laminate mold defining the outer shape of the sheet wound in the shape of a radioidal spring. This mold is performed for example in approximately 2 mm steel plate; although any other adequate measure is not ruled out, forming a template in which the laminate adopts the shape of this mold. Towards the inside of the mold is found the laminate itself or the set of sheets performed with composite materials of a polymer matrix and fiber reinforcement. The shafts that make up the ends of the laminate have been previously integrated with the first turns of the laminate upon itself.

A vacuum bag is then arranged which prevents contact with air and the possible inclusion thereof within the material. This bag also has the mission of holding and compacting the laminate or set of wound sheets or sheets capable of being wound upon themselves.

Finally, an elastomer is arranged in the manufacturing process of the laminate with filling functions and which has two special features. The first of these is that the surface in contact with the laminate is heated to proceed to the curing process of the composite materials with a polymer matrix and fiber reinforcement forming the laminate or the set of sheets and the second special feature is that in addition, in its finishing it closes in a circle, becoming a cylinder closed upon itself and held by the extension of the steel plate of the laminate mold, as if it were a great brace holding the entire assembly, thus preparing it for the curing cycle.

The curing or polymerization cycle is carried out by subjecting the laminate or set of sheets to temperatures of approximately 130° C., a preferred method being by means of pads consisting in about 5 mm thick sheets made of the same elastomer which have inside them electrical resistors calculated in order to reach the curing temperature of the composite material forming the laminate.

Once the laminate is cured, the entire assembly is opened, extracting the laminate in the shape of a distended radioidal spring, i.e. at the equilibrium point where accumulated energy is zero. Once extracted with this shape and when placed in its use position, the laminate or set of wound sheets or sheets that are capable of being wound are wound as a spring in a specific shape, being introduced in the housing or mechanical transmission arranged for its use, with which the elastodynamic accumulator of the invention is thus perfectly finished.

This manufacturing process is one of the many possible processes that can be used and does not rule out the use of any other process that may finally achieve the same production requirements for a sheet of similar characteristics to that of the present invention.

### BRIEF DESCRIPTION OF THE DRAWINGS

In order to complete the description that is being made and with the object of aiding towards a better understanding of the features of the invention, attached to the present specification and as an integral part thereof is a set of drawings in which the following has been represented with an illustrative and non-limiting nature:

FIG. 1 shows a diagrammatic representation of the sheet wound in the shape of a radioidal spiral in a simple configuration, wound upon an shaft that charges and/or supplies (regulates) accumulated energy; and another shaft that charges and/or supplies the same energy; i.e. reversible regarding energy flow.

FIG. 2 shows different types of final springs according to the radioid obtained.

FIGS. 3.1 to 3.3 show different types of mechanical accumulators with one, two, three of four sheets placed in parallel.

FIG. 4 shows the most significant elements in a plan view of the manufacturing mold for the sheet before being closed.

FIG. 5 shows the most characteristic elements that intervene in the manufacturing process and the placement order of such elements within the mold.

FIG. 6 shows a diagrammatic perspective view of the elements that intervene in the manufacturing mold.

FIG. 7 shows a basic diagram of the system possibilities when applied to an energy-generating and hydrogen-producing wind installation.

FIG. 8 shows the application of the elastodynamic energy accumulator-regulator of the invention in transport.

FIG. 9 shows the application of the elastodynamic energy accumulator-regulator of the invention in an Uninterruptible Power Supply (UPS).

### DETAILED DESCRIPTION OF A PREFERRED EMBODIMENT OF THE INVENTION

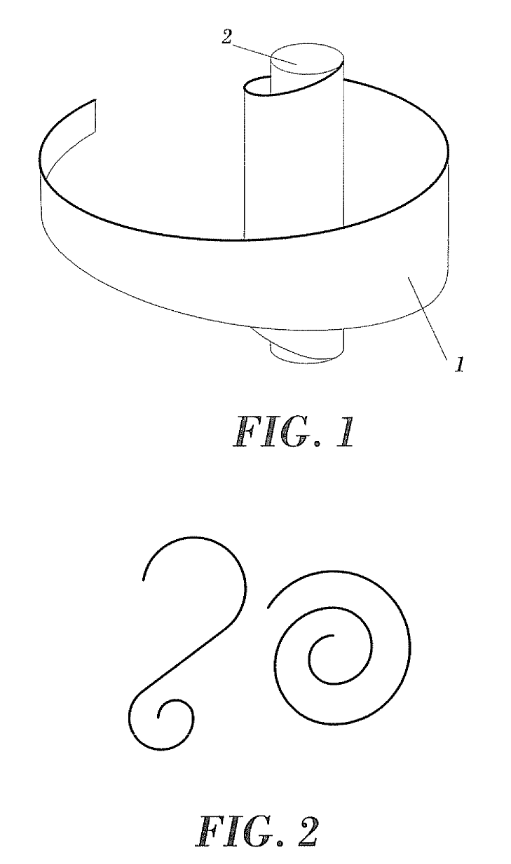

The elastodynamic energy accumulator-regulator proposed by the invention can be seen in diagrammatic form in FIG. 1, and is formed by a sheet (1) that is wound or capable of being wound in radioidal spiral form with increasing or decreasing curvature along the length of the spiral and that is capable of absorbing energy at variable torque and supplying a practically constant torque in broad working areas. This sheet is wound upon itself and its inner end is held to the shaft (2) for charging and/or discharging the energy accumulated in the radioidal spring (1) itself.

This sheet wound in the shape of a radioidal spiral achieves absorbing energy at a variable torque and supplying an almost constant mechanical torque in broad working areas, which makes this mechanical energy accumulation system entirely usable, in contrast to other current mechanical systems in which the torque is not substantially constant either in energy absorption or supply.

The wound sheet or sheet capable of being wound in spiral form has a linearly increasing or decreasing curvature along the length of the spiral, which is an essential feature in order to achieve this supply torque at a practically constant torque in broad working areas. Two of the multiple forms the radioid obtained in the curing process can be seen in FIG. 2.

These figures, although mostly FIG. 1, show the laminate or set of wound sheets or sheets capable of being wound upon themselves in the manner of a spring since they adopt a variable width and/or thickness and/or reinforcement along their length, held on both ends, that is, that with any of the variables or by combining them all an elastodynamic accumulator-regulator that is capable of absorbing energy at a variable torque and supplying it at a constant torque can be achieved, and it is therefore possible to achieve multiple embodiments of the wound sheet in order to obtain the same function.

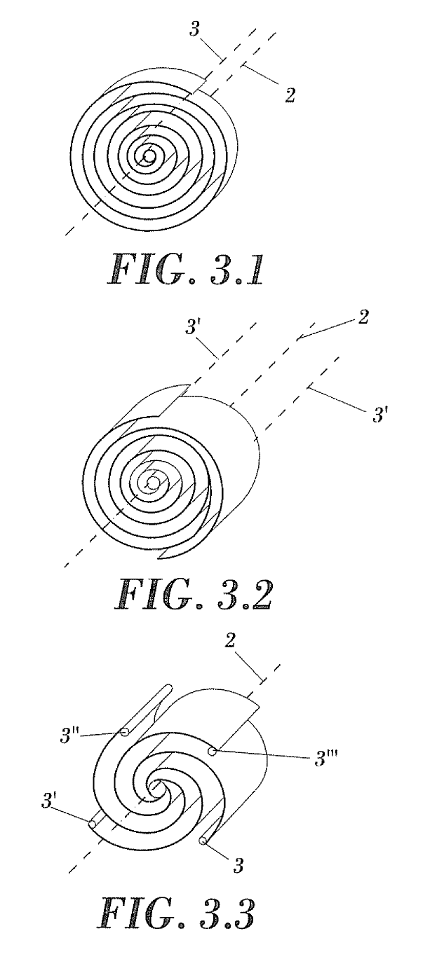

FIG. 3.1 shows a mechanical accumulator with 2 shafts, an inner shaft (2) for input and/or output of the charge and/or discharge movement of the accumulator and an outer shaft (3) for output and/or input, on the final end of the spring.

FIG. 3.2 shows an accumulator formed by two parallel sheets placed upon the same shaft (2) and therefore having two outer output shafts (3) and (3′), the spiral being in this case a double development spiral.

FIG. 3.3 shows an arrangement of four sheets joined upon a single input and/or output shaft (2) and four output and/or input shafts (3), (3′), (3″) and (3″′) that are as out of phase as the spirals that form them.

These sheet arrangements achieve increasing both the charge torque and the discharge torque of the accumulator in proportion to the number of sheets.

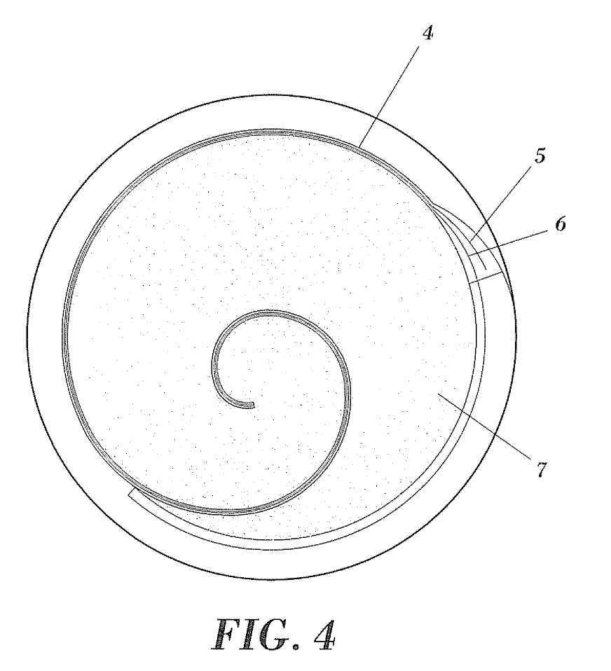

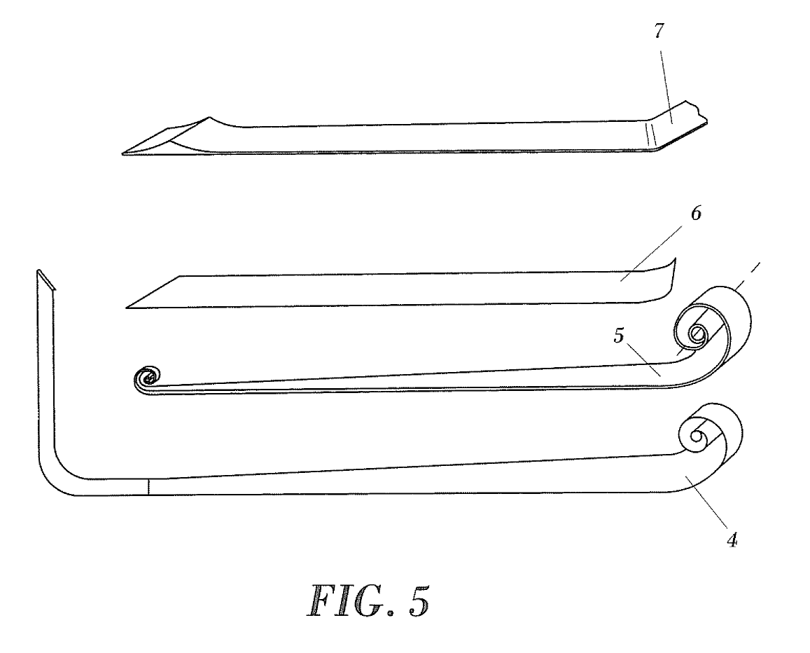

FIGS. 4, 5 and 6 diagrammatically represent the essential and necessary elements in order to achieve the manufacturing process of this sheet that will adequately form the elastodynamic accumulator-regulator.

In order to achieve this, a laminate mold (4) defining the outer shape of the sheet wound in the shape of a radioidal spring is used as a starting point. This mold (4) is performed for example in approximately 2 mm steel plate, forming a template in which the laminate adopts the shape of this mold.

Towards the inside of the mold is found the laminate (5) itself or the set of sheets performed with composite materials of a polymer matrix and fiber reinforcement. The shafts that make up the ends of the laminate have been previously integrated with the first turns of the laminate upon itself.

A vacuum bag (6) is then arranged which prevents contact with air and the possible inclusion thereof within the material. This bag (6) also has the mission of holding and compacting the laminate or set of wound sheets or sheets capable of being wound upon themselves.

Finally, an elastomer (7) is arranged in the manufacturing process of the laminate with filling functions and which has two special features. The first of these is that the surface in contact with the laminate is heated to proceed to the curing process of the composite materials with a polymer matrix and fiber reinforcement forming the laminate or the set of sheets and the second special feature is that also its finishing it closes in a circle, such as shown in the plan view in FIG. 4, becoming a cylinder closed upon itself and held by the extension of the steel plate (4) of the laminate mold, such as if it were a great brace holding the entire assembly, thus preparing it for the curing cycle.

The curing or polymerization cycle is carried out by subjecting the laminate or set of sheets to temperatures of approximately 130° C., a preferred method being by means of pads (not shown in the Figures) consisting in about 5 mm thick sheets made of the same elastomer which have inside them electrical resistances calculated in order to reach the curing temperature of the composite material forming the laminate. The curing temperature will vary with the products used in manufacturing the composite products.

Once the laminate is cured the entire assembly is opened, extracting the laminate in the shape of a distended radioidal spring, i.e. at the equilibrium point where accumulated energy is zero. Once extracted with this shape and when placed in its use position, the laminate or set of wound sheets or sheets that are capable of being wound are wound as a spring in a specific shape, being introduced in the housing or mechanical transmission arranged for its use, with which the elastodynamic accumulator of the invention is thus perfectly finished.

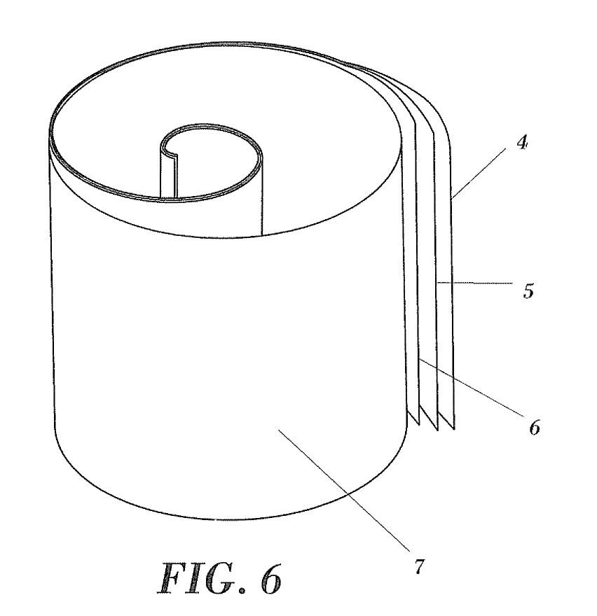

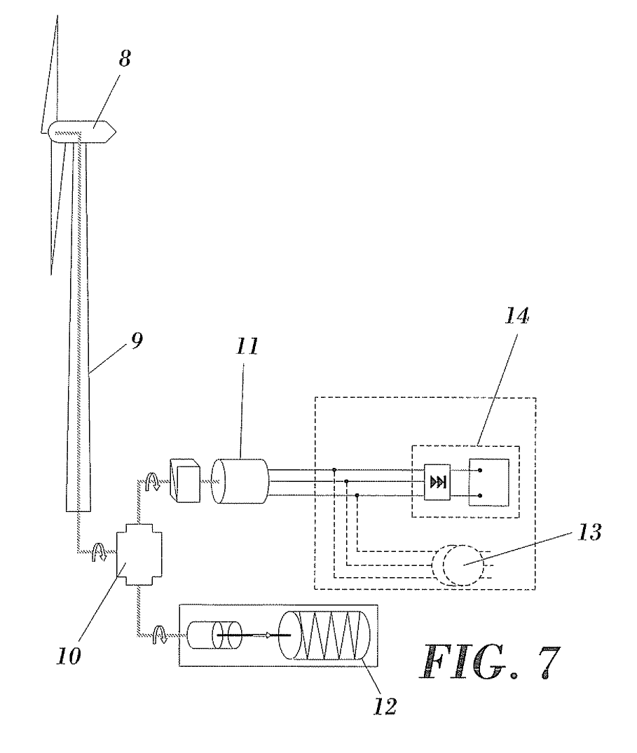

FIG. 6 is an example of the typical application of the elastodynamic energy accumulator of the invention, in which application (8) is arranged the vane device transforming the wind in rotational movement. In this case a horizontal shaft device has been shown, but it could also have been performed with a vertical shaft generator such as those already mentioned above in the specification.

Construction of this wind-powered generator is simpler than current horizontal shaft wind-powered generators, since the head will only have movement transmission elements towards the base, instead of the multiplier elements and the electric generating means of current systems according to the state of the art.

Rotational mechanical movement is transmitted through the mast (9) towards a differential element or a differential group (10) which on one side spreads its movement towards an asynchronous multiplier and generator (11) and on the other end of the differential group towards the elastodynamic energy storage system (12) of the invention.

Energy can be distributed from the asynchronous multiplier and generator (11) towards the outer network (13) when network conditions so advise, or towards a hydrogen generating electrolyzer unit (14) in which energy generated and not provided to the electrical network is not wasted but is instead transformed into a combustible element that can be subsequently used in order to generate electric energy.

The elastodynamic storage system (12) of the invention can elastically store energy thanks to the differential unit or it can provide energy at times of wind shortage, the differential unit being therefore responsible at all times for managing the charging and discharging of the elastodynamic storage system (12) in a fully automatic manner.

The system described would also be appropriate in another of its multiple variants with an inertial energy storage system arranged in parallel. Electrically connected and regulated, being thereby considered as charge, just as the electrolyzers or even the outer network. There are also momentum wheels with direct mechanical connection, i.e. before the generator, using the accumulator to accelerate the wheel mass, although this is not a recommended configuration.

This system also solves the problems of distancing the electric network from wind farms, since they can be as far as can be imagined, since in this case energy production would be consumed for generating hydrogen, which can be stored and transported towards storage and distribution centers.

The elastodynamic energy accumulator-regulator of the invention connected in series with the rotor is suitable for absorbing sudden stresses that would be produced by extreme wind bursts, which are so damaging to the wind-powered generators, since these energy pulses or peaks would be derived to the elastodynamic accumulator-regulator/s in parallel which would perfectly absorb the remaining smaller peaks and would subsequently slowly discharge these towards the generator, the elastodynamic accumulator thus becoming an energy regulator.

The wind-powered generator proposed by the invention comprises
A device (8) capable of transforming kinetic energy from the wind into rotational movement or windmill torque,
mechanical transmission element or conical unit and transmission cables and pulleys or a semi-directed cardan (9) for transmitting said rotational movement
a mechanical differential element or a differential unit (10),
an elastodynamic energy accumulator-regulator (12) comprising a sheet (1) that is wound or capable of being wound in radioidal spiral form with increasing or decreasing curvature along the length of the spiral and that is capable of absorbing energy at variable pair and supply a practically constant pair in broad working areas,
a generator element capable of transforming the mechanical energy into electric energy.

A wind-powered generator has been achieved with this arrangement that is clearly advantageous over current systems in the state of the art.

The mechanical differential element or differential unit (10) has several operating possibilities amongst which the following can be mentioned:
spreading the power of the differential input shaft between two output shafts, one of them for transforming the wind power into electric power and another one for elastodynamic storage of the energy.
Adding up the power of the input and output shafts of the elastodynamic energy accumulator-regulator in order to support the output power towards the output shaft for transforming mechanical energy into electric energy.
Direct transferal of power from the elastodynamic energy accumulator-regulator towards the output shaft for transforming mechanical energy into electric energy.
Power transferal between the elastodynamic energy accumulator-regulator and the differential input shaft capable of starting the wind-powered generator movement with stored energy.

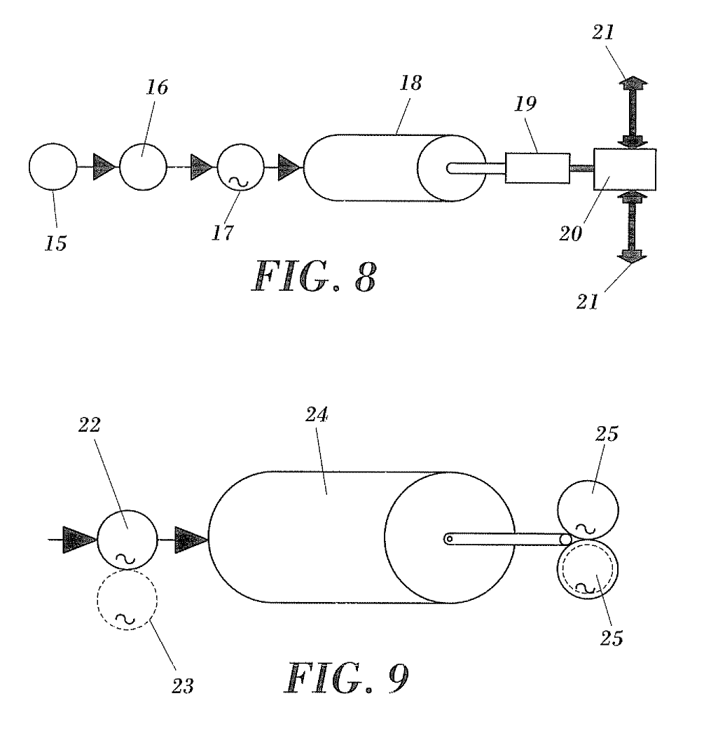

FIG. 8 shows an operation diagram for the elastodynamic energy accumulator-regulator of the invention It can thus be a vehicle provided with a fuel tank (15) that can use hydrogen for operation, hydrogen that supplies the fuel battery (16) and generates electric energy that moves the electric motor (17) to which the elastodynamic accumulator of the invention (18) is joined. The output of this accumulator is transmitted to the continuously variable transmission (19) and from here to the differential unit (20) that is finally transmitted to the wheels (21). The energy flow is completely reversible, allowing both energy transmission and recovery when slowing down the vehicle by elastodynamic energy or mechanical torque absorbed by the accumulator.

This system has great advantages due to the simplicity of the components involved, which has an effect upon system durability and the components involved therein.

FIG. 9 shows application of the elastodynamic energy accumulator-regulator of the invention in Uninterruptible Power Supply systems such as for example in applications for hospitals, automated buildings, transport networks, etc.

This accumulator-regulator allows guaranteeing continuous electric supply within a certain time frame, i.e. without being subject to power cuts or micro-cuts that occur when the main network fails and the auxiliary generator system has to take over, since power input and output are completely independent from each other through the elastodynamic regulation of the accumulator itself.

FIG. 9 shows how the electric network is connected to the motor (22) that is connected to the elastodynamic accumulator (24) the accumulated energy of which will continue to be supplied in a constant manner when the network connection fails. The accumulator output is directed towards the power generator or generators (25) which already generate the electric power for the building. In the event of a network power failure, the accumulator that is at a programmed charge level will continue to move the generators (25) that supply power for the building without producing any kind of power cut, until it is completely discharged.

The system can be complemented with an auxiliary power system based on fuel batteries (23) that would move the motor (22) when the electric network is interrupted for long periods. The elastodynamic energy accumulator-regulator of the invention achieves that there is no power cut in the power supply to the building.

This accumulator can be charged with night-time electric energy at a much lower energy cost and can also include an auxiliary generator system by means of a combustion engine or others.

1. An elastodynamic energy accumulator-regulator comprising
a laminate or set of sheets that is wound in spiral form with a linearly increasing or decreasing curvature along a length of the spiral with variable width and/or thickness and/or reinforcement along the length of the spiral and held on both ends and that absorbs energy at variable torque and supplies a constant torque in a working area.

2. An elastodynamic energy accumulator-regulator according to claim 1, wherein the laminate or set of sheets are made of composite materials with a polymer matrix and fiber reinforcement.

3. An elastodynamic energy accumulator-regulator according to claim 1, comprising at least two sheets that are wound in spiral form with a linearly increasing or decreasing curvature along the length of the spiral, mechanically connected in series, wherein the accumulator-regulator absorbs energy at high variable torque and supplies a practically constant torque in a working area.

4. An elastodynamic energy accumulator-regulator according to claim 1, further comprising at least two sheets that are wound in spiral form with a linearly increasing or decreasing curvature along the length of the spiral, mechanically connected in parallel, wherein the accumulator-regulator absorbs energy at variable torque and supplies a large amount of energy at practically constant torque in a working area.

5. An elastodynamic energy accumulator-regulator according to claim 1, further comprising a laminate of more than two sheets that are wound in spiral form with a linearly increasing or decreasing curvature along the length of the spiral, connected in series and in parallel, wherein the accumulator-regulator absorbs energy at variable torque and supplies a practically constant torque in a working area.

6. An elastodynamic energy accumulator-regulator according to claim 1, wherein it is incorporated to energy production devices by means of coupling through a mechanical differential device which automatically regulates elastodynamic energy supply or accumulation.

7. An energy regulator that absorbs energy excesses and supplies energy at times of shortage configured to elastodynamically accumulates energy with an elastodynamic energy accumulator-regulator according to claim 1.

8. An energy regulator, comprising at least two elastodynamic energy accumulator-regulators according to claim 1 arranged in series.

9. An energy regulator, comprising at least two elastodynamic energy accumulator-regulators according to claim 1 arranged in parallel.

10. An energy regulator, comprising at least two elastodynamic energy accumulator-regulators according to claim 1 arranged and/or combined in series and in parallel.

11. A wind-powered generator comprising:
a device capable of transforming kinetic energy from wind into rotational movement or windmill torque,
a mechanical transmission element of said rotational movement or a conical unit,
a mechanical differential element or a differential unit,
an elastodynamic energy accumulator-regulator,
a generator element capable of transforming mechanical energy into electric energy,
wherein the elastodynamic energy accumulator-regulator comprises a laminate or set of sheets that is wound in spiral form with a linearly increasing or decreasing curvature along a length of the spiral with variable width and/or thickness and/or reinforcement along the length of the spiral and held on both ends and that absorbs energy at variable torque and supplies a constant torque in a working area.

12. A wind-powered generator according to claim 11, wherein the mechanical differential element transmits the rotational torque both to the electric generator element and to the elastodynamic energy accumulator-regulator.

13. A wind-powered generator according to claim 11, capable of transmitting movement from the elastodynamic energy accumulator-regulator to the electric generator by means of the elastodynamic energy accumulated therein, through the differential unit.

14. A wind-powered generator according to claim 11, wherein the elastodynamic energy accumulator-regulator comprises a laminate or set of sheets that is wound in spiral form with a linearly increasing or decreasing curvature along the length of the spiral and absorbs energy at variable torque and supplies a constant torque in a working area.

15. A wind-powered generator according to claim 11, wherein the elastodynamic energy accumulator-regulator comprises a laminate or a set of sheets that is wound in spiral form that has a linearly increasing or decreasing curvature along the length of the spiral.

16. A wind-powered generator according to claim 11, wherein the elastodynamic energy accumulator-regulator comprises a laminate or set of sheets that is wound upon itself in the manner of a spring, having variable thickness and/or width and/or reinforcement along its length, held at its ends.

17. A wind-powered generator according to claim 11, wherein the elastodynamic energy accumulator-regulator comprises a laminate or set of sheets comprising composite materials with a polymer matrix and fiber reinforcement.

18. A wind-powered generator according to claim 11, wherein the elastodynamic energy accumulator-regulator comprises at least two sheets that are wound or capable of being wound in spiral form connected in series, capable of absorbing energy at high variable torque and supplying a practically constant torque in a working area.

19. A wind-powered generator according to claim 11, wherein the elastodynamic energy accumulator-regulator comprises a laminate of two sheets that are wound in spiral form with a linearly increasing or decreasing curvature along the length of the spiral connected in parallel, that absorbs energy at variable torque and supplies a practically constant torque in a working area, providing great energy accumulation.

20. A wind-powered generator according to claim 11, wherein the elastodynamic energy accumulator-regulator comprises a laminate of more than two sheets that are wound in spiral form with a linearly increasing or decreasing curvature along the length of the spiral connected in series and in parallel, that absorbs energy at variable torque and supplies a constant torque in a working area.

21. A hydrogen producing unit comprising:
a mechanical energy producing device,
a transmission element for transmitting said mechanical energy,
a mechanical differential element or a differential unit,
an elastodynamic energy accumulator-regulator comprising a laminate or set of sheets that is wound in spiral form with a linearly increasing or decreasing curvature along the a length of the spiral with variable width and/or thickness and/or reinforcement along the length of the spiral and held on both ends and that absorbs energy at variable torque and supplies a constant torque in a working area,
a generator element capable of transforming the mechanical energy into electric energy,
a hydrogen-producing electrolyzer unit.

22. A hydrogen-producing unit according to claim 21, wherein the elastodynamic energy accumulator-regulator comprises a laminate or set of sheets that is wound in spiral form with a linearly increasing or decreasing curvature along the a length of the spiral with variable width and/or thickness and/or reinforcement along the length of the spiral and held on both ends and that absorbs energy at variable torque and supplies a constant torque in a working area.

23. An auxiliary energy unit comprising the following interconnected elements:
a generator element that transforms electric energy into mechanical energy,
an elastodynamic energy accumulator-regulator comprising a laminate or set of sheets that is wound in spiral form with a linearly increasing or decreasing curvature along the a length of the spiral with variable width and/or thickness and/or reinforcement along the length of the spiral and held on both ends and that absorbs energy at variable torque and supplies a constant torque in a working area,
a device that transforms mechanical energy from the elastodynamic accumulator into electric energy.

24. (canceled)

25. A vehicle provided with a fuel tank that can use hydrogen for its operation, which hydrogen feeds a fuel battery and generates electric energy which is responsible for movement of an electric motor, wherein said electric motor is joined to the elastodynamic energy accumulator-regulator, output of this accumulator being joined to a continuously variable transmission and to a differential group which transmits movement thereof to wheels, wherein the accumulator-regulator comprises a laminate or set of sheets that is wound in spiral form with a linearly increasing or decreasing curvature along the a length of the spiral with variable width and/or thickness and/or reinforcement along the length of the spiral and held on both ends and that absorbs energy at variable torque and supplies a constant torque in a working area.

26. A vehicle according to claim 25, wherein energy flow is completely reversible, allowing both energy transmission and recovery when braking the vehicle by elastodynamic energy or mechanical torque absorbed by the accumulator.

27. A vehicle according to claim 25, wherein the vehicle is an automotive vehicle.

28. A vehicle according to claim 26, wherein the vehicle is a railway vehicle.

29. A vehicle according to claim 26, wherein the vehicle is a marine vehicle.
